(19) United States
(12) Patent Application Publication
(10) Pub. No.: US 2024/0286041 A1
(43) Pub. Date: Aug. 29, 2024

(54) SCREEN DISPLAY METHOD AND APPARATUS, ELECTRONIC DEVICE, AND READABLE STORAGE MEDIUM

(71) Applicant: NETEASE (HANGZHOU) NETWORK CO., LTD., Hangzhou, Zhejiang (CN)

(72) Inventor: Yangchen JIANG, Hangzhou, Zhejiang (CN)

(21) Appl. No.: 18/277,342

(22) PCT Filed: Jul. 25, 2022
(86) PCT No.: PCT/CN2022/107687

§ 371 Date: Aug. 15, 2023

(30) Foreign Application Priority Data
Mar. 17, 2022 (CN) 202210267777.9

(51) Int. Cl. A63F 13/57; A63F 13/52

(52) U.S. Cl. CPC A63F 13/57; A63F 13/52

(57) ABSTRACT

A screen display method and apparatus, an electronic device, and a readable storage medium are provided. When a first virtual character is in a non-following movement state, the first virtual character is controlled to move in a virtual space in response to a movement instruction, and a first game screen of the virtual space where the first virtual character is located is displayed in the graphical user interface; and in response to a following instruction, the first virtual character is controlled to enter a following movement state, and a second game screen of virtual spaces in which other virtual characters are located is displayed in a first preset area of the graphical user interface, where the first virtual character is in a state of following the movement of a target virtual character in the virtual space.

### CROSS-REFERENCE TO RELATED APPLICATION

The present disclosure is the U.S. National Stage Application of PCT International Application No. PCT/CN2022/107687, filed on Jul. 25, 2022, which is based upon and claims the priority to the Chinese Patent Application No. 202210267777.9 filed on Mar. 17, 2022 and entitled “SCREEN DISPLAY METHOD AND APPARATUS, ELECTRONIC DEVICE, AND READABLE STORAGE MEDIUM”, the entire contents of both of which are incorporated by reference herein for all purposes.

### TECHNICAL FIELD

The present disclosure relates to the field of computer technology, and in particular, to a screen display method and apparatus, an electronic device, and a readable storage medium.

### BACKGROUND

In a First-person shooting (FPS) game, each player may have a teammate with whom he can play in cooperation. However, even if the players play for the same team in a game, positions of virtual characters controlled by the players may be far apart from each other. In this case, the players cannot grasp the game dynamics of the teammates in real time; consequently, many opportunities for cooperative play are missed in the game.

Generally, a player needs to search for a teammate and play together with the teammate to grasp the real-time game dynamics of the teammate during the game. However, it takes a lot of game time for the player to search for teammates, and the searching process is actually a process of continuously controlling a virtual character. To continuously control the virtual character in the game, the player needs to continuously apply game instructions to the virtual character through continuous interactive operations. However, frequently applying game instructions will increase the data processing capacity and processing pressure of a terminal; consequently, the process of the player searching for the teammates in the game indirectly increases the operation load of the terminal while slowing down the game progress; and moreover, if the player puts more energy on paying attention to the game dynamics of the teammate in the game, he will be not easy to accurately judge the his own game situation, resulting in mis-operation.

### SUMMARY

The present disclosure provides a screen display method and apparatus, an electronic device, and a non-transitory computer-readable storage medium.

A first aspect of the present disclosure provides a screen display method, including: when a first virtual character corresponding to a terminal is in a non-following movement state, controlling, by the terminal, the first virtual character to move in a virtual space in response to a movement instruction, and displaying a first game screen of the virtual space where the first virtual character is located, in a graphical user interface, where the graphical user interface is provided by the terminal, and a part of a game scene is displayed in the graphical user interface; and in response to a following instruction, controlling the first virtual character to enter a following movement state, and in a first preset area of the graphical user interface, displaying a second game screen of virtual spaces where other virtual characters are located, where the first preset area does not completely block the first game screen, and the following movement state of the first virtual character is a state in which the first virtual character moves automatically according to a movement of a target virtual character in the virtual space.

A second aspect of the present disclosure further provide an electronic device, including a processor, a memory, and a bus, where the memory stores machine-readable instructions executable by the processor, where when the electronic device is running, the processor communicates with the memory through the bus, and the machine-readable instructions, when executed by the processor, perform steps of a screen display method, with the screen display method including: when a first virtual character corresponding to the electronic device is in a non-following movement state, controlling the first virtual character to move in a virtual space in response to a movement instruction, and displaying a first game screen of the virtual space where the first virtual character is located, in a graphical user interface, where a graphical user interface is provided by the electronic device, and a part of a game scene is displayed in the graphical user interface; and in response to a following instruction, controlling the first virtual character to enter a following movement state, and in a first preset area of the graphical user interface, displaying a second game screen of virtual spaces where other virtual characters are located, where the first preset area does not completely block the first game screen, and the following movement state of the first virtual character is a state in which the first virtual character moves automatically according to a movement of a target virtual character in the virtual space.

A third aspect of the present disclosure further provide a non-transitory computer-readable storage medium, with a computer program stored thereon, where the computer program, when executed by a processor, performs steps of a screen display method, with the screen display method including: when a first virtual character corresponding to a terminal is in a non-following movement state, controlling the first virtual character to move in a virtual space in response to a movement instruction, and displaying a first game screen of the virtual space where the first virtual character is located, in a graphical user interface, where a graphical user interface is provided by the terminal, and a part of a game scene is displayed in the graphical user interface; and in response to a following instruction, controlling the first virtual character to enter a following movement state, and in a first preset area of the graphical user interface, displaying a second game screen of virtual spaces where other virtual characters are located, where the first preset area does not completely block the first game screen, and the following movement state of the first virtual character is a state in which the first virtual character moves automatically according to a movement of a target virtual character in the virtual space.

### BRIEF DESCRIPTION OF DRAWINGS

To more clearly illustrate the embodiments of the present disclosure, the drawings required in the embodiments will be briefly described below. It should be understood that the following drawings only illustrate some embodiments of the present disclosure and therefore should not be considered as limitations of the scope, and for those of ordinary skill in the art, other related drawings can be obtained according to these drawings without creative efforts.

FIG. 1 is a flowchart of a screen display method according to an embodiment of the present disclosure;

FIG. 2 is a schematic diagram of a graphical user interface according to an embodiment of the present disclosure;

FIG. 3 is a schematic diagram of an interactive information sending process according to an embodiment of the present disclosure;

FIG. 4 is a schematic diagram of a graphical user interface according to an embodiment of the present disclosure;

FIG. 5 is a schematic diagram of a graphical user interface according to an embodiment of the present disclosure;

FIG. 6 is a schematic diagram of a structure of a screen display apparatus according to an embodiment of the present disclosure;

FIG. 7 is a schematic diagram of a structure of a screen display apparatus according to an embodiment of the present disclosure;

FIG. 8 is a schematic diagram of a structure of a screen display apparatus according to an embodiment of the present disclosure; and

FIG. 9 is a schematic diagram of a structure of an electronic device according to an embodiment of the present disclosure.

### DETAILED DESCRIPTION

Reference will now be described in detail to examples, which are illustrated in the accompanying drawings. The following description refers to the accompanying drawings in which the same numbers in different drawings represent the same or similar elements unless otherwise represented. The examples described following do not represent all examples consistent with the present disclosure. Instead, they are merely examples of devices and methods consistent with aspects of the disclosure as detailed in the appended claims.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . it is determined that”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

It is found through research that, at present, virtual characters controlled by players of the same team are far away from each other due to different game starting places selected by each player among teammates in a game, and in this case, the players in the same team cannot know the game dynamics of each other. To grasp the game state of teammates, a player needs to search for teammates in a game scene, and selects a mode of playing with the teammates to implement real-time monitoring on their game dynamic; or, the player needs to know the game dynamics of the teammates according to the their description through the communication with the them in the game. However, the teammates cannot communicate with each other in real time in the game process. For example, if the teammates cannot timely transmit information to the outside in the process of fighting, or the teammates cannot completely and accurately describe the current game state, the player and the teammates may miss the chance of cooperative play, and further changing the game situation of the teams; and if the player puts most of efforts on observing the game state of teammates, the game progress of the player is affected, the probability of the player making mis-operation is easily increased, and the probability of the player and his/her team winning the game is reduced.

The screen display method in one embodiment of the present disclosure may be operated in a terminal or a server. When the screen display method is operated in the server, the screen display method may be implemented and performed based on a cloud interaction system, where the cloud interaction system includes the server and a client device.

In some examples according to the present disclosure, various cloud applications may be operated under the cloud interaction system, for example, a cloud game. Taking the cloud game as an example, the cloud game refers to a game mode based on cloud computing. In the running mode of the cloud game, a main body for running a game program is separated from a main body for presenting a game screen, and the storage and operation of the information processing method is completed on a cloud game server; the client device is configured to receive and send data and present the game screen, for example, the client device may be a display device with a data transmission function close to the user side, such as a mobile terminal, a television, a computer, and a palm computer; however, the terminal performing information processing is the cloud game server in the cloud. When a game is played, a player operates the client device to send an operation instruction to the cloud game server, the cloud game server runs the game according to the operation instruction, data such as a game screen is coded and compressed, and returned to the client device through a network, and finally, the data is decoded through the client device and the game screen is outputted.

In some examples according to the present disclosure, the local terminal has a game program stored therein and is configured to present a game screen. The local terminal is configured to interact with the player through a graphical user interface, that is, conventionally download, install and run a game program through an electronic device. The manner in which the local terminal provides the graphical user interface to the player may include various modes, for example, the graphical user interface is displayed on a display screen of the terminal by rendering or is provided to the player by holographic projection. By way of example, the local terminal may include a display screen and a processor, where the display screen is configured to present a graphical user interface including game screens, and the processor is configured to run the game, generate the graphical user interface, and control the display of the graphical user interface on the display screen.

An implementation environment provided in one embodiment of the present disclosure may include: a first terminal, a game server, and a second terminal. The first terminal and the second terminal each are communicated with the server to implement data communication. In this example, the first terminal and the second terminal each are installed with a client that executes the screen display method provided by the present disclosure, and the game server is a server end that executes the screen display method provided by the present disclosure. Through the client, the first terminal and the second terminal each can communicate with the game server.

Taking the first terminal as an example, the first terminal establishes communication with the game server by running the client. In some examples according to the present disclosure, the server establishes a game match according to a game request of the client. The parameters of the game match can be determined according to the parameters in the received game request, for example, the parameters of the game match can include a quantity of players participating in the game match, the level of the characters participating in the game match, and the like. When the first terminal receives a response of the server, a virtual scene corresponding to the game match is displayed by a graphical user interface of the first terminal. In some examples according to the present disclosure, the server determines a target game match for the client from a plurality of established game matches according to a game request of the client. When the first terminal receives a response of the server, a virtual scene corresponding to the game match is displayed by a graphical user interface of the first terminal. The first terminal is a device controlled by a first user, a player character displayed in the graphical user interface of the first terminal is a virtual character controlled by the first user, and the first user inputs an operation instruction through the graphical user interface, so as to control the player character to perform a corresponding operation in the virtual scene.

Taking the second terminal as an example, the second terminal establishes communication with the game server by running the client. In some examples according to the present disclosure, the server establishes a game match according to a game request of the client. The parameters of the game match can be determined according to the parameters in the received game request, for example, the parameters of the game match can include a quantity of players participating in the game match, the level of the characters participating in the game match, and the like. When the second terminal receives a response of the server, a virtual scene corresponding to the game match is displayed by a graphical user interface of the second terminal. In some examples according to the present disclosure, the server determines a target game match for the client from a plurality of established game matches according to a game request of the client. When the second terminal receives a response of the server, a virtual scene corresponding to the game match is displayed by a graphical user interface of the second terminal. The second terminal is a device controlled by a second user, a player character displayed in the graphical user interface of the second terminal is a virtual character controlled by the second user, and the second user inputs an operation instruction through the graphical user interface, so as to control the player character to perform a corresponding operation in the virtual scene.

The server performs data calculation according to the game data reported by the first terminal and the second terminal, and synchronizes the calculated game data to the first terminal and the second terminal, so that the first terminal and the second terminal control the graphical user interface to render a corresponding virtual scene and/or player characters according to the synchronization data delivered by the server.

Herein, a player character controlled by the first terminal and a player character controlled by the second terminal are player characters in the same game match. The player character controlled by the first terminal and the player character controlled by the second terminal may have the same character attribute or may have different character attributes.

It should be noted that, the player characters in the current game match may include two or more player characters, and different player characters may correspond to different terminals. That is, in the current game match, there are more than two terminals that perform sending and synchronization of game data with the game server separately.

Based on this, an embodiment of the present disclosure provides a screen display method, in which players can grasp the real-time game status of teammates without searching for the teammates in the game, which reduces the process of players searching for the teammates in the game, thus reducing indirectly the interactive operations between players and terminals in the game.

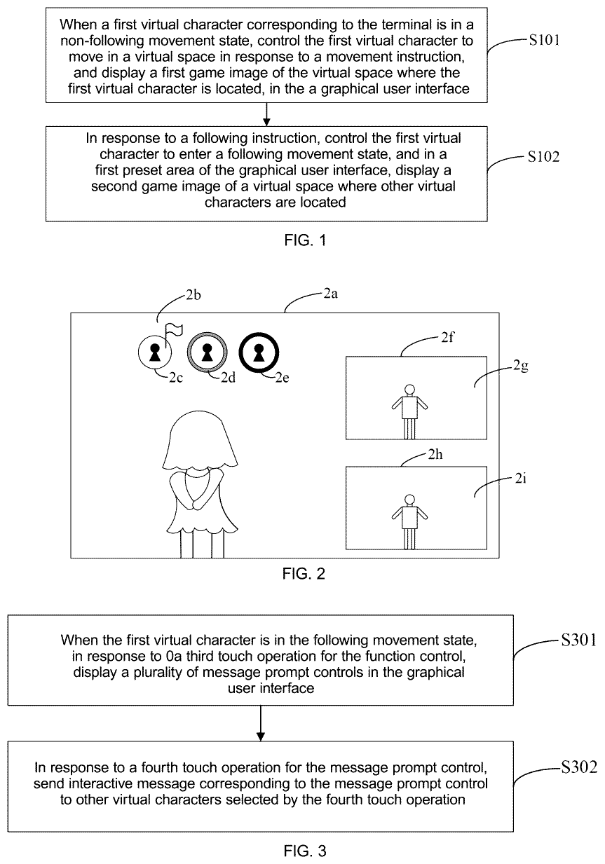

Referring to FIG. 1, FIG. 1 is a flowchart of a screen display method according to an embodiment of the present disclosure. A graphical user interface is provided by a terminal, and a part of a game scene is displayed in the graphical user interface. As shown in FIG. 1, the screen display method provided by an embodiment of the present disclosure includes:

S101: when a first virtual character corresponding to the terminal is in a non-following movement state, controlling, in response to a movement instruction, the first virtual character to move in a virtual space, and displaying a first game screen of the virtual space where the first virtual character is located in the graphical user interface.

S102: controlling, in response to a following instruction, the first virtual character to enter a following movement state, and displaying a second game screen of a virtual space where other virtual characters are located in a first preset area of the graphical user interface, where the first preset area does not completely block the first game screen, and the following movement state of the first virtual character is a state in which the first virtual character moves automatically according to movement of a target virtual character in the virtual space.

In an embodiment of the present disclosure, when the first virtual character controlled by a first player is in a following movement state, to enable the first player to grasp the game dynamics of other virtual characters in real time, a first preset area that does not completely block a first game screen displayed in a graphical user interface may be set in the graphical user interface of the first player, and second game screen of another virtual character is displayed in the first preset area, so that the monitoring of the game dynamics of other virtual characters is implemented, which is helpful for the first player to grasp the game dynamics of other virtual characters in real time. In addition, since the first virtual character is in the following movement state in this case, the first player can give sufficient attention to other virtual characters in the game, thereby helping to avoid the frequency of mis-operation of the first player in order to monitor the game dynamics of other virtual characters, and indirectly increasing the winning probability of the first player and his/her team.

The game scene is a scene in which a first virtual character controlled by a first player, a target virtual character, or other virtual characters are located when a game task is executed in the game. Specifically, a first virtual character controlled by the first player, a target virtual character, other virtual characters, a non-player character (NPC), and other virtual objects (for example, virtual buildings, virtual vegetation, and virtual shops) may be displayed in the game scene, and a first virtual object controlled by the first player may reach any position in the game scene according to the control of the first player to execute a corresponding game task, and the like.

Herein, the non-following movement state means that the first virtual character controlled by the first player moves in the game scene according to the control of the first player, that is, how the first virtual character moves in the game scene (for example, a moving direction, a moving speed, and a moving state of the first virtual character) depends on the control of the first player. The first player can control the first virtual character to move in the virtual space by delivering a movement instruction to the first virtual character, for example, the first player delivers a movement instruction by touching a direction control, and the movement instruction can include a moving direction (for example, 60° northeast), a moving speed (for example, 1 m/s), and a moving state (for example, a hasting state) of the first virtual character. In this case, the first virtual character is controlled to move 60° in the northeast direction at a speed of 1 m/s in the virtual space in the hasting state according to the movement instruction delivered by the first player.

The virtual space refers to a three-dimensional space or a two-dimensional space set by a game scene. The movement of a target virtual character in the game scene is actually the movement in the virtual space set by the game scene, and the game scene displayed in the graphical user interface changes along with the movement of the target virtual character in the virtual space.

The first game screen refers to a screen of a game scene in a virtual space in which the first virtual character is currently located in the game. The display content in the first game screen may change according to a screen presentation perspective selected by the first player, for example, when the first player selects to present the first game screen with a first-person perspective, in this case, the first game screen may include only a part of the first virtual character, for example, a hand of the first virtual character; and when the first player selects to present the first game screen with a third-person perspective, the whole first virtual character in the first game screen can be displayed to the first player.

In the example provided by the present disclosure, the first virtual character is controlled to move in a virtual space in response to a movement instruction. Specifically, when the first player presses an operation key corresponding to a movement control, a movement instruction for controlling the first virtual character to move in the virtual space may be delivered, and the first virtual character is controlled to move in the virtual space. The first player can deliver a movement instruction by touch operations such as clicking and dragging and/or by a preset combination keys. Specifically, the player can touch the movement control by a finger, a mouse, and the like; or by preset combination keys in the keyboard, for example, Ctrl, Alt, and A in the keyboard, where the preset keys may be manually set according to the requirements of the first player.

In the step S101, when a first virtual character controlled by a first player is in a non-following movement state in the game, the first player may deliver a movement instruction to the first virtual character by touching a movement control or a preset combination key, etc., and the first virtual character may move in a virtual space of a game scene according to an indication of the movement instruction after receiving the movement instruction. The movement instruction may include a moving speed (e.g., 1 m/s), a moving direction (e.g., northeast direction and southeast direction), and a moving mode (e.g., running and hasting) of the first virtual character in the virtual space, and the like.

Meanwhile, a first game screen of a virtual space in which the first virtual character is located in the moving process is displayed in the graphical user interface.

The following movement state means that the first virtual character controlled by the first player follows the target virtual character to move in the game scene, that is, how the first virtual character moves in the game scene depends on the target virtual character. Specifically, the moving direction, the moving speed, the moving mode, and the like of the first virtual character in the virtual space all depend on the target virtual character.

As an example, when the target virtual character moves to the northeast of the virtual space in a hasting state, the first virtual character may follow the target virtual character to move to the northeast of the virtual space in the hasting state.

In the step S102, the first virtual character may be controlled to enter the following movement state in response to the following instruction. In this case, the first player does not need to control the first virtual character on the movement, and the first virtual character may follow the target virtual character to move in the virtual space.

In an example, a following instruction that triggers the first virtual character to enter a following movement state is generated by: generating the following instruction in response to a following condition meeting a preset following requirement.

The following condition meeting the preset following requirement includes at least one of: receiving a following movement instruction delivered by the first player; the first virtual character entering an area associated with the target virtual character.

Specifically, a first player can trigger a first virtual character to enter a state of following a target virtual character to move by accepting a following invitation sent by the target virtual character in the game, where the following invitation is triggered by the player to which the target virtual character belongs through touching a corresponding control (such as a following invitation control) and/or a preset combination keys. Specifically, after the player to which the target virtual character belongs touches the following instruction control, the following invitation may be sent to the first player, and after the first player accepts the following invitation, this target virtual character may be determined as the target virtual character selected to be followed by the first player, and it is determined that the following condition of the first virtual character controlled by the first player meets the preset following requirement.

When the first virtual character enters the following movement state, there may be a certain distance between the first virtual character and the target virtual character, that is, the first virtual character may follow the target virtual character to move in the virtual space at a long distance. For example, from south to north are sequentially a position A of the first virtual character, a position B of the target virtual character, and a position C of a destination of the target virtual character; the target virtual character starts from the position B, if the distance between the position B and the position A is smaller than or equal to a preset distance threshold, the player controlling the target virtual character can initiate a following invitation to the first player, where if the first player accepts the following invitation from the player controlling the target virtual character, the first virtual character may start from position A and follow the target virtual character to move towards the position C.

Or, if the target virtual character is a specific non-player character related to the game task currently executed by the first virtual character, when the first virtual character controlled by the first player enters the area associated with the target virtual character, the first virtual character is automatically triggered to enter a following movement state. That is, when the first virtual character enters the area associated with the target virtual character, the target virtual character is determined as the target virtual character selected to be followed by the first player, and it is determined that the following condition of the first virtual character controlled by the first player meets the preset following requirement.

In the step S102, the first virtual character is controlled, in response to the following instruction, to follow the target virtual character in a following movement state to move in the virtual space; a first game screen of a virtual space in which the first virtual character is located in the moving process is displayed in the graphical user interface. Meanwhile, to allow the first player to grasp the game dynamics of other virtual characters in the same team in real time or the game dynamics of other virtual characters such as a specific non-player character in the game, a first preset area can be set in a superimposition manner in the graphical user interface, and a second game screen of a virtual space in which other virtual characters are located is selected to be displayed in the first preset area. Since the first player cannot know the game dynamic of the target virtual character even before the first virtual character moves to join the target virtual character due to the fact that the first virtual character follow the target virtual character to move at a long distance, the game screen in the virtual space in which the target virtual character is located may also be selected to be displayed in the first preset area, and thus, other virtual characters may include a target virtual character, a virtual character in the same team as the first player, a specific non-player character, and the like.

In addition, the displayed first preset area does not completely block the first game screen, so that the first player can give comprehensive attention to the game state of the first virtual character while paying attention to the game dynamics of other virtual characters, avoiding the mis-operation resulted from the first player missing a fighting opportunity due to untimely attention.

The attribute information of other virtual characters also can be displayed in the first preset area, for example, a moving direction and a moving state of other virtual characters, the health point, the defense power and the attack power of the other virtual characters, and a relative distance between other virtual characters and the first virtual character, so as to help the first player to grasp the game state of the other virtual characters.

The first preset area may be displayed in a form of a floating window in the graphical user interface.

To enable the first player to view the game states of different other virtual characters, the first player may switch or add an additional perspective by displaying the player identifier on the graphical user interface, that is, switch the second game screen displayed in the first preset area or add a third game screen, and the like, to implement an increase in the perspective viewed by the first player.

The content of the second game screen of the virtual space in which other virtual characters are located depends on the content of the game screen displayed in the graphical user interface of the players to which other virtual characters belong. Specifically, the content of the second game screen may be consistent or inconsistent with the game screen viewed by the players to which the other virtual characters belong; specifically, the acquired game screen content of the player to which another virtual character belongs can be directly used as the content of the second game screen and displayed in the first preset area; or after the game screen content of the player to which another virtual character belongs is acquired, the display perspective of the game screen of the player to which another virtual characters belong is converted according to the display perspective selected by the first player, so as to obtain the second game screen displayed in the first preset area, for example, the game screen of the player to which another virtual characters belongs is displayed in the graphical user interface of the players with a first-person perspective, and the first player selects to view the game screen of the player to which another virtual character belongs with a third-person perspective. In this case, the game screen of the player to which another virtual character belongs needs to be converted into the third personal perspective to obtain the second game screen, and the second game screen is displayed in the first preset area.

In an example, character identifiers of other virtual characters in a same team as the first virtual character are displayed in the graphical user interface; and the screen display method further includes: when the first virtual character is in a following movement state, selecting, in response to a first touch operation for the character identifier, a second virtual character from other virtual characters; and displaying a third game screen of a virtual space in which the second virtual character is located in the graphical user interface.

The character identifiers of the other virtual characters in the same team as the first virtual character can be displayed in the graphical user interface in the game of the first virtual character. The character identifiers of other virtual characters may be identifiers related to players to which other virtual characters belong, for example, a player's avatar, a player's nickname, and a player's ID; or may be some identifiers of the other virtual characters themselves, for example, a character's image and a character's name.

When the first virtual character is in a following movement state, in response to a first touch operation applied to any one of the character identifiers, a second virtual character selected by the first touch operation is determined from other virtual characters, and a third game screen of a virtual space in which the second virtual character is located is displayed in a graphical user interface.

To avoid unnecessary blocking on the graphical user interface caused by repeated screen display in the graphical user interface, the second virtual character is another virtual character except the first virtual character and the target virtual character.

In the example provided by the present disclosure, a second virtual character is selected from the other virtual characters in response to a first touch operation for the character identifier. Specifically, when the character identifier is pressed down, a selection instruction of the second virtual character can be delivered, and the second virtual character is selected from the other virtual characters. The player can deliver a selection instruction by touch operations such as clicking and dragging and/or by preset combination keys. Specifically, the player may touch the player identifier by a finger, a mouse, and the like; or by preset combination keys in the keyboard, for example, Ctrl, Alt, and A in the keyboard, and the preset keys may be manually set according to the requirements of the player.

In an example, the displaying a third game screen of a virtual space in which the second virtual character is located in the graphical user interface includes: switching the second game screen displayed in the first preset area to the third game screen; and/or displaying the third game screen in a second preset area displayed by the graphical user interface.

In this step, if the first preset area is displayed in the current graphical user interface in a superimposition manner, and the second game screen of the virtual space in which the other virtual characters are located is displayed in the first preset area, when the first player presses the character identifier by the first touch operation, the second game screen displayed in the first preset area may be switched to the third game screen of the virtual space in which the second virtual character is located.

In addition, to allow the first player to simultaneously control the game dynamics of a plurality of virtual characters, a plurality of preset areas can be displayed in the graphical user interface, so that the player can more comprehensively control the game dynamics of the virtual characters in the game.

As an example, a second preset area may be set in a superimposition manner in an area other than the first preset area in the graphical user interface, and a third game screen of the second virtual character may be displayed in the second preset area; therefore, the first player can view the second game screen of another virtual character through the first preset area and view the third game screen of the second virtual character through the second preset area, and the first game screen, the second game screen and the third game screen can be viewed simultaneously.

The second preset area may be displayed in a form of a floating window in the graphical user interface. For the purpose of prompting the first player, when the controlled object of the target virtual character followed by the first virtual character is another player in the same team as the first player, the character identifier of the target virtual character is highlighted, where the character identifier of the target virtual character may be a player identifier of the player controlling the target virtual character, that is, a player identifier of a player to which the target virtual character belongs. For example, a special symbol is displayed at the player identifier of the controlled player of the target virtual character, for example, a flag may be displayed beside the player identifier.

Meanwhile, the character identifier of the second virtual character and the character identifier of the target virtual character in the graphical user interface may also be highlighted, for example, a halo is displayed on an outer circle of the character identifier of the second virtual character (and/or the character identifier the target virtual character).

The character identifiers of the other virtual characters may be identifiers related to players to which the other virtual characters belong, for example, a player's avatar, a player's nickname, and a player's ID; or may be some identifiers of the other virtual characters themselves, for example, a character's image and a character's name.

The character identifier of the target virtual character may be an identifier related to a player to which the target virtual character belongs, for example, a player's avatar, a player's nickname, and a player's ID; or may be some identifiers of the target virtual character, for example, a character's image and a character's name.

The character identifier of the second virtual character may be an identifier related to a player to which the second virtual character belongs, for example, a player's avatar, a player's nickname, and a player's ID; or may be some identifiers of the second virtual character, for example, a character's image and a character's name.

Referring to FIG. 2, FIG. 2 is a first schematic diagram of a graphical user interface according to an embodiment of the present disclosure. As shown in FIG. 2, a first game screen 2b of a virtual space in which a first virtual character is located, character identifiers 2c-2e, and a first preset area 2f are displayed in a graphical user interface 2a, and the first virtual character currently follows the target virtual character corresponding to the character identifier 2c to move in the virtual space to which the game scene belongs; a second game screen 2g of another virtual character (not shown in the figure) corresponding to a character identifier 2d is displayed in a first preset area 2; when the first player touches the character identifier 2e through a first touch operation, a second preset area 2h is displayed in the graphical user interface 2a in a superimposition manner, and a third game screen 21 of a second virtual character (not shown in the figure) corresponding to the character identifier 2e is displayed in the second preset area 2 h; further, the character identifier 2c is highlighted by “one flag”, and the character identifier 2d and the character identifier 2e are highlighted by different colors of halos.

To facilitate communication between a first player and teammates thereof in the game, a communication control specially set for the first player is usually provided on a graphical user interface, and a message to be sent to the teammates is determined by touching the communication control. However, the communication control set additionally inevitably blocks the game interface of the first player to a greater or lesser extent. To reduce excessive blocking on the first game screen, according to an embodiment of the present disclosure, when the first virtual character is in a following movement state, a function control displayed in the graphical user interface can be multiplexed functionally, so that a quantity of controls to be displayed in the graphical user interface is reduced, and the first game screen is prevented from being blocked.

In an example, a function control is displayed in the graphical user interface; the controlling a first virtual character to move in a virtual space in response to a movement instruction when the first virtual character corresponding to the terminal is in a non-following movement state includes: when the first virtual character is in a non-following movement state, controlling, in response to a second touch operation for the function control, the first virtual character to move in a virtual space.

In this step, when the first virtual character is in a non-following movement state, the first player may control the first virtual character to move in the virtual space by touching a function control displayed in the graphical user interface.

The first player may communicate movement information, including a moving direction (for example, 60° northeast), a moving speed (for example, 1 m/s), and a moving state (for example, a hasting state) to the first virtual character by touching the function control.

The function control includes a movement control used to control the virtual character to move in the game scene, a skill control used to control the virtual character to release a skill in the game scene, a backpack control used to control the virtual character to open a virtual backpack, an information interaction control used to control the virtual character to send interaction information to other virtual characters, and other controls.

In an example, referring to FIG. 3, FIG. 3 is a schematic diagram of an interactive information sending process according to an embodiment of the present disclosure. As shown in FIG. 3, the screen display method further includes: step S301: when the first virtual character is in a following movement state, displaying, in response to a third touch operation for the function control, a plurality of message prompt controls in the graphical user interface; and step S302: sending, in response to a fourth touch operation for the message prompt controls, interactive information corresponding to the message prompt controls to other virtual characters selected by the fourth touch operation.

In this step, to reduce a quantity of controls displayed in the graphical user interface and avoid excessive blocking on the graphical user interface, when the first virtual character is in the following movement state, the function controls originally having other functions may be functionally multiplexed. For example, when the first virtual character is in the non-following movement state, the first player may control the first virtual character to move in the virtual space by touching the function control, and when the first virtual character enters the following movement state, the first virtual character may send shortcut information to other players in the same team by applying a third touch operation to the function control, so that the communication between players is increased.

Alternatively, when the first virtual character is in the non-following movement state, the first player may release a skill by touching a function control, and when the first virtual character enters the following movement state, the first virtual character may send shortcut information to other players in the same team by applying a third touch operation to the function control, so that the communication between players is increased.

As an example, when the first virtual character is in the following movement state, the first player touches a function control through a third touch operation. In this case, a plurality of message prompt controls are displayed in the graphical user interface, and each message prompt control corresponds to one piece of interaction information.

The first player may apply a fourth touch operation to any one of the message prompt controls, and sends the interaction information corresponding to the message prompt controls to a third virtual character selected by the fourth touch operation, so as to implement communication between the first player to which the first virtual character belongs and a player to which the third virtual character belongs.

The second touch operation and the third touch operation may be same with each other, and for example, both the second touch operation and the third touch operation are clicking operations. Alternatively, the second touch operation and the third touch operation may be different from each other, and for example, the second touch operation is a clicking operation while the third touch operation is a sliding operation.

Therefore, the function control originally controlling the first virtual character is used to send the interactive information among the players when the first virtual character is in the following movement state, and the functional multiplexing of the controls is implemented, so that a quantity of the controls displayed in the graphical user interface is reduced, the rendering pressure of the terminal in the process of rendering the graphical user interface is indirectly reduced, and the response efficiency of the terminal is improved.

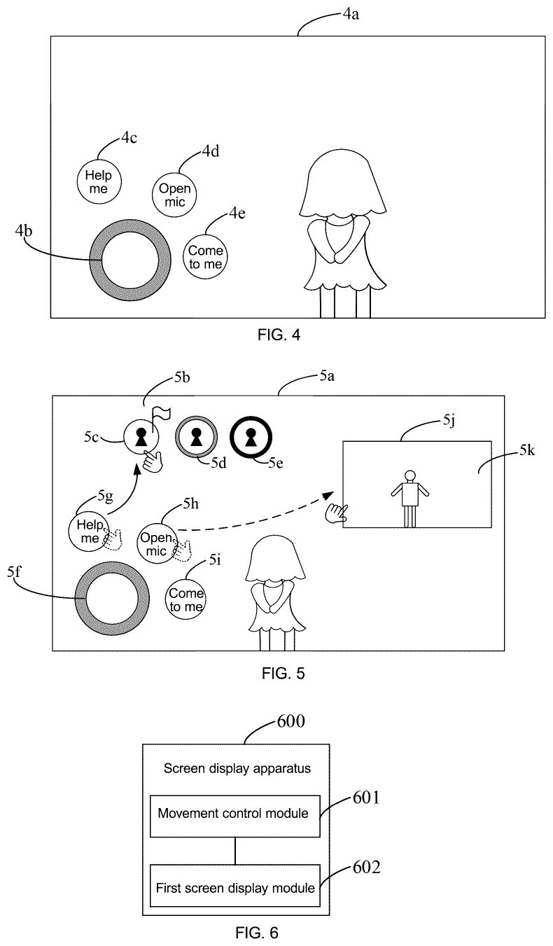

Referring to FIG. 4, FIG. 4 is a second schematic diagram of a graphical user interface according to an embodiment of the present disclosure. As shown in FIG. 4, when the first virtual character is in the following movement state, a function control 4b is displayed in the graphical user interface 4a, and when the first player touches the function control 4b, message prompt controls 4c-4e are displayed in the graphical user interface 4a.

The message prompt controls are determined by the manner of: determining the message prompt controls according to any one or more of the first reference parameters below, with the first reference parameters including:
a character attribute of the first virtual character, where the message prompt controls displayed in the graphical user interface can be determined according to the character attribute of the first virtual character, where the character attribute includes one or more of character health point, character defense power, character attack power, character damage power, and a position in which the character is located; for example, when the first virtual character is in a low health point, a distress-type message prompt control such as “help me” may be displayed;
a team attribute of a team to which the first virtual character belongs, where a message prompt control displayed in the graphical user interface may be determined according to team attribute of a team to which the first virtual character belongs, where the team attribute includes one or more of team game progress, a quantity of surviving teammates in the team, and positions in which teammates in the team are located; for example, when the team to which the first virtual character belongs has significant advantages and has a high probability of winning, an attack-type message prompt control such as “initiate attack to XXX” may be displayed; and
a game task currently executed by the first virtual character, where a message prompt control displayed in the graphical user interface may also be determined according to a currently executing game task of the first virtual character; for example, the game task currently executed by the first virtual character requires cooperation of teammates to complete, and in this case, a collection-type message prompt control such as “come to me” may be displayed.

Therefore, the player can quickly send the interactive information by touching the message prompt controls, and the interactive efficiency among the players in the game is improved.

To facilitate players to send interactive messages in the game, the present disclosure provides a variety of ways to send message.

In an example, the fourth touch operation is a sliding touch operation, and step S302 includes: determining, in response to the end of the sliding touch operation for the message prompt controls, an end position of the sliding touch operation; if the end position is located in an area covered by the first preset, determining another virtual character to which the second game screen belongs as a third virtual character; or if the end position is located in a response range of another character identifier, determining a virtual character corresponding to another character identifier as a third virtual character; and sending the interactive information corresponding to the message prompt controls to the third virtual character.

In this step, when the fourth touch operation is a sliding touch operation, an end position of the sliding touch operation is determined, and if the end position is located in a response range of any one of the other character identifiers, the virtual character to which the located character identifier belongs is determined as a third virtual character selected by the fourth operation. Other character identifiers may be character identifiers of virtual characters in the same team as the first virtual character.

Alternatively, if the end position is located in an area covered by a first preset area in the graphical user interface, another virtual character to which the second game screen displayed in the first preset area belongs is determined as the third virtual character selected by the sliding operation; and the interactive information corresponding to the message prompt controls is sent to the third virtual character.

Similarly, if a second preset area is still displayed in the graphical user interface in this case, when the end position is located in an area covered by the second preset area, the second virtual character to which the third game screen displayed in the second preset area belongs is determined as the third virtual character.

Referring to FIG. 5, FIG. 5 is a third schematic diagram of a graphical user interface according to an embodiment of the present disclosure. As shown in FIG. 5, a first game screen 5b, character identifiers 5c-5e, a function control 5f, message prompt controls 5g-5i, and a first preset area 5j are displayed in a graphical user interface 5a, and a third game screen 5k of a second virtual character (not shown in the figure) is displayed in the first preset area 5j; when the first player drags the message control 5g to the character identifier 5c (as shown by the solid line in FIG. 5), the virtual character corresponding to the character identifier 5c is determined as a third virtual character (not shown in the figure); when the first player drags the message prompt control 5h to the area covered by the first preset area 5j (as shown by the dotted line in FIG. 5), the second virtual character (not shown in the figure) to which the third game screen belongs is determined as the third virtual character (not shown in the figure).

Therefore, the player can select a corresponding interactive information sending mode according to the actual situation to implement the quick sending of the interactive information, so that the interactive efficiency among the players in the game is improved. In an example, the fourth touch operation is a clicking touch operation, and the step S302 includes: determining, in response to a clicking touch operation for the message prompt controls, a virtual character in a same team as the first virtual character as the third virtual character; and sending the interactive information corresponding to the message prompt controls to the third virtual character.

In this step, if the fourth touch operation applied to any one of the message prompt controls by the first player is a clicking touch operation, all virtual characters belonging to the same team as the first player are determined as the third virtual character, and the interaction information corresponding to the message prompt controls is sent to all virtual characters belonging to the same team as the first player, that is, the interaction information corresponding to the message prompt controls is mass-sent to virtual characters controlled by other players belonging to the same team as the first player.

Therefore, the player may implement mass sending of the interactive information with other players belonging to the same team through one-time touch operation, which reduces the operation complexity of mass sending information in the game.

To increase the communication mode among teammates in the same team, a possibility of performing quick voice communication with teammates is provided for the first player. Meanwhile, the purpose of reducing the function controls displayed in the graphical user interface can be implemented, and excessive blocking on the first game screen is avoided. When the first virtual character is in a following movement state, the function controls displayed in the graphical user interface may be functionally multiplexed.

In an example, the screen display method further includes: when the first virtual character is in a following movement state, entering a voice input state in response to a fifth touch operation for the function control; and sending voice information received in the voice input state as interactive information to a fourth virtual character selected by the fifth touch operation.

In this step, when the first virtual character is in the following movement state, the function controls originally having other functions may be functionally multiplexed. For example, when the first virtual character is in the non-following movement state, the first player may control the first virtual character to move in the virtual space by touching the function control, and when the first virtual character enters the following movement state, the first player may enter a voice input state by applying a fifth touch operation to the function control, so that the first player may input voice information in the voice input state, and may send the voice information input by the first player as interaction information to a fourth virtual character selected by a fifth touch operation.

The fifth touch operation may be a sliding touch operation, a clicking touch operation, a double-clicking touch operation, a long-pressing touch operation, and the like, or may be a combined operation of a long-pressing touch operation and a sliding touch operation.

For example, when the fifth touch operation is a combined touch operation of a long-pressing touch operation and a sliding touch operation, a voice input state is entered in response to the long-pressing touch operation for a function control, and in this case, the first player may input voice information. The voice input state is exited in response to the start of the sliding touch operation in the combined touch operation. An end position of the sliding touch operation in the combined touch operation is determined, that is, an end position of the combined touch operation is determined. If the end position of the combined touch operation is located on any player identifier, a virtual character that corresponds to the player identifier and is controlled by other players is determined as a fourth virtual character selected by the combined touch operation, that is, as a fourth virtual character selected by a fifth touch operation. Alternatively, if the end position of the combined touch operation is located in an area covered by a first screen floating window in the graphical user interface, another virtual character to which the second game screen displayed in the first screen floating window belongs is determined as a fourth virtual character selected by the combined touch operation, that is, as a fourth virtual characters selected by the fifth touch operation; and the voice information is sent to the fourth virtual character.

Similarly, if a second screen floating window is still displayed in the graphical user interface in this case, when an end position of the combined touch operation is located in an area covered by the second screen floating window, the second virtual character to which the third game screen displayed in the second screen floating window belongs is determined as a fourth virtual character.

To facilitate the operation of a first player in the game, an embodiment of the present disclosure further provides the first player with a variety of ways to exit the following movement state.

In an example, a function control is displayed in the graphical user interface; and the screen display method further includes: when the first virtual character is in a following movement state, controlling, in response to a sixth touch operation for the function control, the first virtual character to exit the following movement state.

In this step, when the first virtual character is in the following movement state, if the player wants to exit this following movement, a function key may be touched through a sixth touch operation to control the first virtual character to exit the following movement state.

In another embodiment, a following cancellation control is displayed in the graphical user interface; and the screen display method further includes: when the first virtual character is in a following movement state, controlling, in response to a seventh touch operation for the following cancellation control, the first virtual character to exit this following movement state.

In this step, a following cancellation control is set for the first player in the graphical user interface, and when the first virtual character is in a following movement state, the first player can touch the following cancellation control by a seventh touch operation to control the first virtual character to exit this following movement state.

There is a great possibility that the first virtual character may encounter an adversarial virtual character during the process of following the target virtual character to move. To further increase the interaction between the first virtual character and the target virtual character, the first virtual character may implement an attack on the adversarial virtual character through a function control, such as a skill release control displayed in the graphical user interface in the process of following movement.

In an example, a function control is displayed in the graphical user interface; and the screen display method further includes: when the first virtual character is in a following movement state, controlling, in response to an eight touch operation for the function control, the first virtual character to attack the adversarial virtual character.

In this step, when the first virtual character encounters an adversarial virtual character in the process of following the second virtual character to move, the attack on the adversarial virtual character can be initiated by the function control displayed in the graphical user interface. Specifically, an eighth touch operation can be applied to the function control to control the first virtual character to release the responded attack skill, so that the first virtual character can attack the adversarial virtual character by touching a function control in the process of following movement.

During the game, the first player may also implement the switching of the followed objects through the displayed character identifier. In an example, when the first virtual character is in a following movement state, a followed virtual character except the target virtual character is selected from the followed virtual characters in response to a ninth touch operation for the character identifier; and the first virtual character is controlled to follow the followed virtual character to move in the virtual space.

In this step, when the first virtual character encounters other followable virtual characters in the process of following the second virtual character to move, the followed object can be switched through the character identifier of the followable virtual characters displayed in the graphical user interface. Specifically, a followable virtual character to be switched can be selected from the followable virtual characters by a ninth touch operation, and the first virtual character is controlled to follow the determined followable virtual character to move in the virtual space; and if the switching cannot be performed, the prompt information indicating that it cannot be switched is displayed in the graphical user interface, so as to achieve the purpose of prompting the first player. According to the screen display method provided by an embodiment of the present disclosure, a part of a game scene is displayed in a graphical user interface. When a first virtual character controlled by a first player is in a non-following movement state, the first virtual character is controlled to move in a virtual space in response to a movement instruction delivered by the first player, and a first game screen of the virtual space in which the first virtual character is located is displayed in the graphical user interface; the first virtual character is controlled to enter a following movement state in response to a following condition meeting a preset following requirement; when the first virtual character is in the following movement state, the first virtual character is controlled to follow the target virtual character to move in the virtual space, a first game screen is displayed in a graphical user interface, a first screen floating window is displayed in a graphical user interface, and a second game screen of the virtual space in which other virtual characters are located is displayed in the first screen floating window. Therefore, players can still grasp the real-time game status of teammates without searching for the teammates, which reduces the process of players searching for the teammates in the game, thus reducing indirectly the interactive operations between players and terminals in the game; meanwhile, the mis-operation of the players in the searching process is avoided, and the winning rate of a first player and a team to which the first player belongs may be indirectly improved.

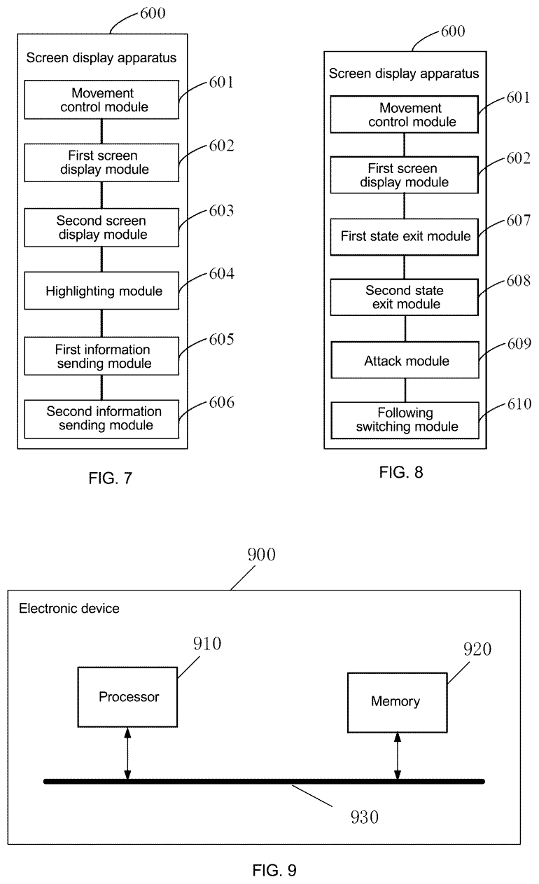

Referring to FIGS. 6 to 8, FIG. 6 is a first schematic diagram of a structure of a screen display apparatus according to an embodiment of the present disclosure, FIG. 7 is a second schematic diagram of a structure of a screen display apparatus according to an embodiment of the present disclosure, and FIG. 8 is a third schematic diagram of a structure of a screen display apparatus according to an embodiment of the present disclosure. A graphical user interface is provided by a terminal, and a part of a game scene is displayed in the graphical user interface. As shown in FIG. 6, the screen display apparatus 600 includes:
a movement control module 601, configured to: when a first virtual character corresponding to the terminal is in a non-following movement state, control the first virtual character to move in a virtual space in response to a movement instruction, and display a first game screen of the virtual space in which the first virtual character is located in the graphical user interface; and
a first screen display module 602, configured to: control the first virtual character to enter a following movement state in response to a following instruction, and display a second game screen of a virtual space in which other virtual characters are located in a first preset area of the graphical user interface, where the first preset area does not completely block the first game screen, and the following movement state of the first virtual character is a state in which the first virtual character moves automatically according to movement of a target virtual character in the virtual space.

Further, as shown in FIG. 7, a character identifier of another virtual character in a same team as the first virtual character is displayed in the graphical user interface; and the screen display apparatus 600 further includes a second screen display module 603, where the second screen display module 603 is configured to:
when the first virtual character is in a following movement state, select a second virtual character from the other virtual characters in response to a first touch operation for the character identifier; and
display a third game screen of a virtual space in which the second virtual character is located in the graphical user interface.

Further, when the second screen display module 603 is configured to display a third game screen of a virtual space in which the second virtual character is located in the graphical user interface, the second screen display module 603 is configured to:
switch the second game screen displayed in the first preset area into the third game screen; and/or
display the third game screen in a second preset area presented by the graphical user interface.

Further, as shown in FIG. 7, the screen display apparatus 600 further includes a highlighting module 604, where the highlighting module 604 is configured to:
highlight a character identifier of the second virtual character in the graphical user interface; and/or
highlight a character identifier of the target virtual character; and/or
highlight a character identifier of another virtual character.

Further, as shown in FIG. 7, a function control is displayed in the graphical user interface; the movement control module 601 controls, when a first virtual character corresponding to the terminal is in a non-following movement state, the first virtual character to move in a virtual space in response to a movement instruction, and the movement control module 601 is configured to:
when the first virtual character is in a non-following movement state, control the first virtual character to move in a virtual space in response to a second touch operation for the function control;
the screen display apparatus 600 further includes a first information sending module 605, where the first information sending module 605 is configured to:
when the first virtual character is in a following movement state, display a plurality of message prompt controls in the graphical user interface in response to a third touch operation for the function; and
send, in response to a fourth touch operation for the message prompt controls, interactive information corresponding to the message prompt controls to a third virtual character selected by the fourth touch operation.

Further, the fourth touch operation is a sliding touch operation, and when the first information sending module 605 is configured to send, in response to a fourth touch operation for the message prompt controls, interactive information corresponding to the message prompt controls to a third virtual character selected by the fourth touch operation, the first information sending module 605 is configured to:
determine an end position of the sliding touch operation in response to the end of the sliding touch operation for the message prompt controls;
if the end position is located in the first preset area, determine another virtual character to which the second game screen belongs as a third virtual character; or if the end position is located in a response range of other character identifiers, determine a virtual character corresponding to another character identifier as a third virtual character; and
send the interactive information corresponding to the message prompt controls to the third virtual character.

Further, the fourth touch operation is a clicking touch operation, and when the first information sending module 605 is configured to send, in response to a fourth touch operation for the message prompt controls, interactive information corresponding to the message prompt controls to a third virtual character selected by the fourth touch operation, the first information sending module 605 is configured to:
determine a virtual character in a same team as the first virtual character as the third virtual character in response to a clicking touch operation for the message prompt controls; and
send the interactive information corresponding to the message prompt controls to the third virtual character.

Further, as shown in FIG. 7, the screen display apparatus 600 further includes a second information sending module 606, where the second information sending module 606 is configured to:
when the first virtual character is in a following movement state, enter a voice input state in response to a fifth touch operation for the function control; and
send voice information received in the voice input state as interactive information to a fourth virtual character selected by the fifth touch operation.

Further, as shown in FIG. 8, a function control is displayed in the graphical user interface; and the screen display apparatus 600 further includes a first state exit module 607, where the first state exit module 607 is configured to:
when the first virtual character is in a following movement state, control the first virtual character to exit the following movement state in response to a sixth touch operation for the function control.

Further, as shown in FIG. 8, a following cancellation control is displayed in the graphical user interface; and the screen display apparatus 600 further includes a second state exit module 608, where the second state exit module 608 is configured to:
when the first virtual character is in a following movement state, control the first virtual character to exit the following movement state in response to a seventh touch operation for the following cancellation control.

Further, the first screen display module is configured to generate a following instruction by the following manner:
generating the following instruction in response to a following condition meeting a preset following requirement, where the following condition meeting the preset following requirement includes at least one of:
receiving a following movement instruction for controlling the first virtual character to move in a game scene; and
the first virtual character entering an area associated with the target virtual character.

Further, the first information sending module 605 is configured to determine the message prompt controls by the manner of:
determining the message prompt controls according to any one or more of the first reference parameters below; a character attribute of the first virtual character, a team attribute of a team to which the first virtual character belongs, and a game task currently executed by the first virtual character, where the character attribute includes one or more of character health point, character defense power, character attack power, character damage power, and a position in which the character is located, the team attribute includes one or more of team game progress, a quantity of surviving teammates in the team, and positions in which teammates in the team are located.

Further, a function control is displayed in the graphical user interface; and the screen display apparatus 600 further includes an attack module 609, where the attack module 609 is configured to:
when the first virtual character is in a following movement state, control the first virtual character to attack an adversarial virtual character in response to an eighth touch operation for the function control.

Further, a function control is displayed in the graphical user interface; and the screen display apparatus 600 further includes a following switching module 610, where the following switching module 610 is configured to:
when the first virtual character is in a following movement state, select a followed virtual character except the target virtual character from the followable virtual characters in response to a ninth touch operation for the character identifiers of the followable virtual characters; and
control the first virtual character to follow the followed virtual character to move in the virtual space.

According to the screen display apparatus provided by an embodiment of the present disclosure, a graphical user interface is provided by a terminal, and a part of a game scene is displayed in the graphical user interface, when a first virtual character corresponding to the terminal is in a non-following movement state, the first virtual character is controlled to move in a virtual space in response to a movement instruction, and a first game screen of the virtual space in which the first virtual character is located is displayed in the graphical user interface; and the first virtual character is controlled to enter a following movement state in response to a following instruction, and a second game screen of a virtual space in which other virtual characters are located is displayed in a first preset area of the graphical user interface, where the first preset area does not completely block the first game screen, and the following movement state of the first virtual character is a state in which the first virtual character moves automatically according to movement of a target virtual character in the virtual space. Therefore, players can still grasp the real-time game status of teammates without searching for the teammates, which reduces the process of players searching for the teammates in the game, so that the response frequency of the terminal in the game is indirectly reduced; meanwhile, the mis-operation of the players in the searching process is avoided, and the winning rate of a first player and a team to which the first player belongs may be indirectly improved.

Referring to FIG. 9, FIG. 9 is a schematic diagram of a structure of an electronic device according to an embodiment of the present disclosure. As shown in FIG. 9, the electronic device 900 includes a processor 910, a memory 920, and a bus 930.

The memory 920 has machine-readable instructions stored thereon and executable by the processor 910, and when the electronic device 900 is running, the processor 910 communicates with the memory 920 through the bus 930, such that the processor 910, when running, executes the below instructions of:
when a first virtual character corresponding to the terminal is in a non-following movement state, controlling the first virtual character to move in a virtual space in response to a movement instruction, and displaying a first game screen of the virtual space in which the first virtual character is located in the graphical user interface; and
controlling the first virtual character to enter a following movement state in response to a following instruction, and displaying a second game screen of a virtual space in which another virtual character is located in a first preset area of the graphical user interface, where the first preset area does not completely block the first game screen, and the following movement state of the first virtual character is a state in which the first virtual character moves automatically according to movement of a target virtual character in the virtual space.

The players can still grasp the real-time game status of teammates without searching for the teammates, which reduces the process of players searching for the teammates in the game, so that the response frequency of the terminal in the game is indirectly reduced.

In a possible example, the method of the instructions executed by the processor 910 further includes:
when the first virtual character is in a following movement state, selecting a second virtual character from the other virtual characters in response to a first touch operation for the character identifier; and
displaying a third game screen of a virtual space in which the second virtual character is located in the graphical user interface.

In the process of the first virtual character following the target virtual character to move, the second virtual character can be quickly selected by touching the displayed character identifier, and the monitoring of the game state of the second virtual character is implemented.

In a possible example, in the method of the instructions executed by the processor 910, the displaying a third game screen of a virtual space in which the second virtual character is located in the graphical user interface includes:
switching the second game screen displayed in the first preset area into the third game screen; and/or
displaying the third game screen in a second preset area displayed by the graphical user interface.

A display position of the third game screen of the second virtual character in the graphical user interface may be appropriately arranged to avoid unnecessary blocking on the first game screen displayed in the graphical user interface.

In a possible example, the method of the instructions executed by the processor 910 further includes:
highlighting a character identifier of the second virtual character in the graphical user interface; and/or
highlighting a character identifier of the target virtual character; and/or
highlighting a character identifier of the other virtual characters.

The character identifiers of different virtual characters can be highlighted in the graphical user interface so as to achieve the purpose of prompting the player, further, the player is prevented from repeatedly delivering interface switching instructions in the game, and the response frequency of the terminal in the game is reduced.

In a possible example, in the method of the instructions executed by the processor 910, a function control is displayed in the graphical user interface; and the controlling a first virtual character to move in a virtual space in response to a movement instruction when the first virtual character corresponding to the terminal is in a non-following movement state includes:
when the first virtual character is in a non-following movement state, controlling the first virtual character to move in a virtual space in response to a second touch operation for the function control; and
the screen display method further includes:
when the first virtual character is in a following movement state, displaying a plurality of message prompt controls in the graphical user interface in response to a third touch operation for the function control; and
sending, in response to a fourth touch operation for the message prompt controls, interactive information corresponding to the message prompt controls to a third virtual character selected by the fourth touch operation.

The function control displayed in the graphical user interface may be functionally multiplexed, so that a quantity of controls to be displayed in the graphical user interface is reduced, and the first game screen is prevented from being blocked.

In a possible example, in the method of the instructions executed by the processor 910, the sending in response to a fourth touch operation for the message prompt controls interactive information corresponding to the message prompt controls to a third virtual character selected by the fourth touch operation includes:
determining an end position of the sliding touch operation in response to the end of the sliding touch operation for the message prompt controls;
if the end position is located in the first preset area, determining another virtual character to which the second game screen belongs as a third virtual character; or if the end position is located in a response range of other character identifiers, determining a virtual character corresponding to another character identifiers as a third virtual character; and
sending the interactive information corresponding to the message prompt controls to the third virtual character.

The function control originally controlling the first virtual character is used to send the interactive information among the players when the first virtual character is in the following movement state, and the functional multiplexing of the controls is implemented, so that a quantity of the controls displayed in the graphical user interface is reduced, the rendering pressure of the terminal in the process of rendering the graphical user interface is indirectly reduced, and the response efficiency of the terminal is improved.

In a possible example, in the method of the instructions executed by the processor 910, the sending in response to a fourth touch operation for the message prompt controls the interactive information corresponding to the message prompt controls to a third virtual character selected by the fourth touch operation includes:
determining a virtual character in a same team as the first virtual character as the third virtual character in response to a clicking touch operation for the message prompt controls; and
sending the interactive information corresponding to the message prompt controls to the third virtual character.

The player can quickly send the interactive information by touching the message prompt controls, and thus the interactive efficiency among the players in the game is improved.

In a possible example, the method of the instructions executed by the processor 910 further includes:
when the first virtual character is in a following movement state, entering a voice input state in response to a fifth touch operation for the function control; and
sending voice information received in the voice input state as interactive information to a fourth virtual character selected by the fifth touch operation.

Various ways of sending interactive information to teammates are provided for players in the game, so that the players can send voices to the teammates in the game, and the efficiency of interaction among the players is improved.

In a possible example, the method of instructions executed by the processor 910 further includes:
when the first virtual character is in a following movement state, controlling the first virtual character to exit the following movement state in response to a sixth touch operation for the function control.

The function control displayed in the graphical user interface may be functionally multiplexed, so that a quantity of controls to be displayed in the graphical user interface is reduced, and the first game screen is prevented from being blocked.

In a possible example, the method of the instructions executed by the processor 910 further includes:
when the first virtual character is in a following movement state, controlling the first virtual character to exit the following movement state in response to a seventh touch operation for the following cancellation control.

The player is provided with the possibility of exiting the following movement state at any time in the game process, and the man-machine interaction efficiency in the game process is improved.

In a possible example, in the instructions executed by the processor 910, a following instruction is generated by the manner of:
generating the following instruction in response to a following condition meeting a preset following requirement, where the following condition meeting the preset following requirement includes at least one of:
receiving a following movement instruction for controlling the first virtual character to move in a game scene; and
the first virtual character entering an area associated with the target virtual character.

In a possible example, in the instructions executed by the processor 910, the message prompt controls are determined by the manner of:
determining the message prompt controls according to any one or more of the first reference parameters below; a character attribute of the first virtual character, a team attribute of a team to which the first virtual character belongs, and a game task currently executed by the first virtual character, where the character attribute includes one or more of character health point, character defense power, character attack power, character damage power, and a position in which the character is located, and the team attribute includes one or more of team game progress, a quantity of surviving teammates in the team, and positions in which teammates in the team are located.

In a possible example, the method of the instructions executed by the processor 910 further includes:
when the first virtual character is in a following movement state, controlling the first virtual character to attack an adversarial virtual character in response to an eighth touch operation for the function control.

The original function control can be functionally multiplexed when the first virtual character is in a following movement state, and an attack on an adversarial virtual character is implemented by the function control, so that a quantity of controls needing to be displayed in a graphical user interface is reduced, and the first game screen is prevented from being blocked.

In a possible example, the method of the instructions executed by the processor 910 further includes:
when the first virtual character is in a following movement state, selecting a followed virtual character except the target virtual character from the followable virtual characters in response to a ninth touch operation for the character identifier of the followable virtual character; and
controlling the first virtual character to follow the followed virtual character to move in the virtual space.

The followed object can be switched at any time during the following movement of the first virtual character, so that the complexity of switching the followed object is reduced, and the complexity of game operation is reduced.

An embodiment of the present disclosure further provides a non-transitory computer-readable storage medium, where the computer-readable storage medium has a computer program stored thereon, such that the computer program executes the following instructions when run by the processor:
when a first virtual character corresponding to the terminal is in a non-following movement state, controlling the first virtual character to move in a virtual space in response to a movement instruction, and displaying a first game screen of the virtual space in which the first virtual character is located in the graphical user interface; and
controlling the first virtual character to enter a following movement state in response to a following instruction, and displaying a second game screen of a virtual space in which other virtual characters are located in a first preset area of the graphical user interface, where the first preset area does not completely block the first game screen, and the following movement state of the first virtual character is a state in which the first virtual character moves automatically according to movement of a target virtual character in the virtual space.

The players can still grasp the real-time game status of teammates without searching for the teammates, which reduces the process of players searching for the teammates in the game, so that the response frequency of the terminal in the game is indirectly reduced.

In a possible example, the method of the instructions executed by the computer-readable storage medium further includes:
when the first virtual character is in a following movement state, selecting a second virtual character from the other virtual characters in response to a first touch operation for the character identifier; and
displaying a third game screen of a virtual space in which the second virtual character is located in the graphical user interface.

In the process of the first virtual character following the target virtual character to move, the second virtual character can be quickly selected by touching the displayed character identifier, and the monitoring of the game state of the second virtual character is implemented.

In a possible example, in the instructions executed by the computer-readable storage medium, the displaying a third game screen of a virtual space in which the second virtual character is located in the graphical user interface includes:
switching the second game screen displayed in the first preset area to the third game screen; and/or
displaying the third game screen in a second preset area displayed by the graphical user interface.

A display position of the third game screen of the second virtual character in the graphical user interface may be appropriately arranged to avoid unnecessary blocking on the first game screen displayed in the graphical user interface.

In a possible example, the method of the instructions executed by the computer-readable storage medium further includes:
highlighting a character identifier of the second virtual character in the graphical user interface; and/or
highlighting a character identifier of the target virtual character; and/or
highlighting character identifiers of other virtual characters.

The character identifiers of different virtual characters can be highlighted in the graphical user interface so as to achieve the purpose of prompting the player, further, the player is prevented from repeatedly delivering interface switching instructions in the game, and the response frequency of the terminal in the game is reduced.

In a possible example, in the instructions executed by the computer-readable storage medium, a function control is displayed in the graphical user interface; the controlling a first virtual character to move in a virtual space in response to a movement instruction when the first virtual character corresponding to the terminal is in a non-following movement state includes:
when the first virtual character is in a non-following movement state, controlling the first virtual character to move in a virtual space in response to a second touch operation for the function control; and
the screen display method further includes:
when the first virtual character is in a following movement state, displaying a plurality of message prompt controls in the graphical user interface in response to a third touch operation for the function control; and
sending, in response to a fourth touch operation for the message prompt controls, interactive information corresponding to the message prompt controls to a third virtual character selected by the fourth touch operation.

The function control displayed in the graphical user interface may be functionally multiplexed, so that a quantity of controls to be displayed in the graphical user interface is reduced, and the first game screen is prevented from being blocked.

In a possible example, in the instructions executed by the computer-readable storage medium, the sending in response to a fourth touch operation for the message prompt controls interactive information corresponding to the message prompt controls to a third virtual character selected by the fourth touch operation includes:
determining an end position of the sliding touch operation in response to the end of the sliding touch operation for the message prompt controls:
if the end position is located in the first preset area, determining another virtual character to which the second game screen belongs as a third virtual character; or if the end position is located in a response range of other character identifiers, determining a virtual character corresponding to another character identifier as a third virtual character; and
sending the interactive information corresponding to the message prompt controls to the third virtual character.

The function control originally controlling the first virtual character is used to send the interactive information among the players when the first virtual character is in the following movement state, and the functional multiplexing of the controls is implemented, so that a quantity of the controls displayed in the graphical user interface is reduced, the rendering pressure of the terminal in the process of rendering the graphical user interface is indirectly reduced, and the response efficiency of the terminal is improved.

In a possible example, in the instructions executed by the computer-readable storage medium, the sending in response to a fourth touch operation for the message prompt controls, interactive information corresponding to the message prompt controls to a third virtual character selected by the fourth touch operation includes:
determining a virtual character in a same team as the first virtual character as the third virtual character in response to a clicking touch operation for the message prompt controls; and
sending the interactive information corresponding to the message prompt controls to the third virtual character.

The player can quickly send the interactive information by touching the message prompt controls, and the interactive efficiency among the players in the game is improved.

In a possible implementation, the method of the instructions executed by the computer-readable storage medium further includes:
when the first virtual character is in a following movement state, entering a voice input state in response to a fifth touch operation for the function control; and
sending voice information received in the voice input state as interactive information to a fourth virtual character selected by the fifth touch operation.

Various ways of sending interactive information to teammates are provided for players in the game, so that the players can send voices to the teammates in the game, and the efficiency of interaction among the players is improved.

In a possible example, the method of the instructions executed by the computer-readable storage medium further includes:
when the first virtual character is in a following movement state, controlling the first virtual character to exit the following movement state in response to a sixth touch operation for the function control.

The function control displayed in the graphical user interface may be functionally multiplexed, so that a quantity of controls to be displayed in the graphical user interface is reduced, and the first game screen is prevented from being blocked.

In a possible implementation, the method of the instructions executed by the computer-readable storage medium further includes:
when the first virtual character is in a following movement state, controlling the first virtual character to exit the following movement state in response to a seventh touch operation for the following cancellation control.

The player is provided with the possibility of exiting the following movement state at any time in the game process, and the man-machine interaction efficiency in the game process is improved.

In a possible example, in the instructions executed by the computer-readable storage medium, a following instruction is generated by the following manner:
generating the following instruction in response to a following condition meeting a preset following requirement, where the following condition meeting the preset following requirement includes at least one of:
receiving a following movement instruction for controlling the first virtual character to move in a game scene; and
the first virtual character entering an area associated with the target virtual character.

In a possible example, in the instructions executed by the computer-readable storage medium, the message prompt controls are determined by the manner of:
determining the message prompt controls according to any one or more of the first reference parameters below; a character attribute of the first virtual character, a team attribute of a team to which the first virtual character belongs, and a game task currently executed by the first virtual character, where the character attribute includes one or more of character health point, character defense power, character attack power, character damage power, and a position in which the character is located, the team attribute includes one or more of team game progress, a quantity of surviving teammates in the team, and positions in which teammates in the team are located.

In a possible example, the method of the instructions executed by the computer-readable storage medium further includes:
when the first virtual character is in a following movement state, controlling the first virtual character to attack an adversarial virtual character in response to an eighth touch operation for the function control.

The original function control can be functionally multiplexed when the first virtual character is in a following movement state, and an attack on an adversarial virtual character is implemented by the function control, so that a quantity of controls needing to be displayed in a graphical user interface is reduced, and the first game screen is prevented from being blocked.

In a possible example, the method of the instructions executed by the computer-readable storage medium further includes:
when the first virtual character is in a following movement state, selecting a followed virtual character except the target virtual character from the followable virtual characters in response to a ninth touch operation for the character identifier of the followable virtual character; and
controlling the first virtual character to follow the followed virtual character to move in the virtual space.

The followed object can be switched at any time during the following movement of the first virtual character, so that the complexity of switching the followed object is reduced, and the complexity of game operation is reduced.

According to the screen display method and apparatus, the electronic device, and the readable storage medium provided by embodiments of the present disclosure, a graphical user interface is provided by a terminal, and a part of a game scene is displayed in the graphical user interface; when a first virtual character corresponding to the terminal is in a non-following movement state, in response to a movement instruction, the first virtual character is controlled to move in a virtual space, and a first game screen of the virtual space where the first virtual character is located is displayed in the graphical user interface; and in response to a following instruction, the first virtual character is controlled to enter a following movement state, and a second game screen of virtual spaces where other virtual characters are located is displayed in a first preset area of the graphical user interface, where the first preset area does not completely block the first game screen, and the following movement state of the first virtual character is a state in which the first virtual character moves automatically according to a movement of a target virtual character in the virtual space. Therefore, players can still grasp the real-time game status of teammates without searching for the teammates, which reduces the process of players searching for the teammates in the game, thus reducing indirectly the interactive operations between players and terminals in the game; meanwhile, the mis-operation of the players in the searching process is avoided, and the winning rate of a first player and a team to which the first player belongs may be indirectly improved.

It may be clearly understood by those skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present disclosure, it should be understood that the disclosed system, apparatus and method may be implemented in other manners. The apparatus embodiment described above is merely illustrative. For example, the division of the units is only a division based on logical function, and it can be implemented in other ways in an actual situation. For another example, a plurality of units or components may be combined or integrated into another system, or some features may be omitted or not implemented. In addition, the shown or discussed coupling or direct coupling or communicative connection between each other may be through some communicative interfaces, and indirect coupling or communicative connection between apparatuses or units may be in electrical, mechanical or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, the functional units in the embodiments of the present disclosure may be integrated into one processing unit, or each unit may exist alone physically, or two or more units are integrated into one unit.

The function, if implemented in a form of a software functional unit and sold or used as an independent product, can be stored in a non-volatile computer-readable storage medium executable by a processor. Based on such understanding, the technical solutions of the present disclosure essentially can be, or part of the technical solutions contributing to the prior art can be, or part of the technical solutions can be embodied in the form of a software product. The computer software product is stored in a storage medium and includes several instructions for enabling a computer device (which can be a personal computer, a server, a network device or the like) to implement all or part of the steps of the method described in the embodiments of the present disclosure. The foregoing storage medium includes any medium that can store program code, such as a USB flash drive, a removable hard disk, a read-only memory (ROM), a random access memory (RAM), a magnetic disk, or an optical disc.

It should be noted that the foregoing embodiments are only specific implementations of the present disclosure, and are used to illustrate the technical solutions of the present disclosure, but not for limiting the present disclosure, and the protection scope of the present disclosure is not limited thereto. Although the present disclosure is described in detail with reference to the foregoing embodiments, those of ordinary skill in the art should understand that; a person skilled in the art may still modify or easily think of changes to the technical solutions described in the foregoing embodiments within the technical scope disclosed in the present disclosure, or equivalent replacements can still be made to some technical features thereof. These modifications, changes, or substitutions do not make the essence of the corresponding technical solutions depart from the spirit and scope of the technical solutions of the embodiments of the present disclosure, and shall fall within the protection scope of the present disclosure. Therefore, the protection scope of the present disclosure shall be subject to the protection scope of the claims.

1. A screen display method, comprising:
when a first virtual character corresponding to a terminal is in a non-following movement state, controlling, by the terminal, the first virtual character to move in a virtual space in response to a movement instruction, and displaying a first game screen of the virtual space where the first virtual character is located, in a graphical user interface, wherein the graphical user interface is provided by the terminal, and a part of a game scene is displayed in the graphical user interface; and
in response to a following instruction, controlling the first virtual character to enter a following movement state, and in a first preset area of the graphical user interface, displaying a second game screen of virtual spaces where other virtual characters are located, wherein the first preset area does not completely block the first game screen, and the following movement state of the first virtual character is a state in which the first virtual character moves automatically according to a movement of a target virtual character in the virtual space.

2. The screen display method according to claim 1, wherein character identifiers of the other virtual characters are displayed in the graphical user interface, wherein the other virtual characters are in a same team as the first virtual character; and
wherein the screen display method further comprises:
when the first virtual character is in the following movement state, in response to a first touch operation for the character identifiers, selecting a second virtual character from the other virtual characters; and
displaying a third game screen of the virtual space where the second virtual character is located, in the graphical user interface.

3. The screen display method according to claim 2, wherein displaying the third game screen of the virtual space where the second virtual character is located in the graphical user interface comprises:
switching the second game screen displayed in the first preset area to the third game screen; or
displaying the third game screen in a second preset area presented by the graphical user interface.

4. The screen display method according to claim 2, further comprising:
highlighting a character identifier of the second virtual character in the graphical user interface; or
highlighting a character identifier of the target virtual character; or
highlighting the character identifiers of the other virtual characters.

5. The screen display method according to claim 1, wherein a function control is displayed in the graphical user interface; and
wherein controlling the first virtual character to move in the virtual space in response to the movement instruction further comprises:
when the first virtual character is in the non-following movement state, in response to a second touch operation for the function control, controlling the first virtual character to move in a virtual space; and
wherein the screen display method further comprises:
when the first virtual character is in the following movement state, in response to a third touch operation for the function control, displaying a plurality of message prompt controls in the graphical user interface; and
in response to a fourth touch operation for a message prompt control, sending interactive information corresponding to the message prompt control to third virtual character selected by the fourth touch operation.

6. The screen display method according to claim 5, wherein the fourth touch operation is a sliding touch operation; and wherein sending the interactive information corresponding to the message prompt control to the third virtual character selected by the fourth touch operation further comprises:
in response to an end of the sliding touch operation for the message prompt control, determining an end position at which the sliding touch operation ends, and
in response to determining that the end position is located in the first preset area, the other virtual characters are determined as third virtual character, wherein the other virtual characters are located in the second game screen; or in response to determining that the end position is located in a response range of other character identifiers, the virtual characters corresponding to the other character identifiers are determined as third virtual character; and
sending the interactive information corresponding to the message prompt control to the third virtual character.

7. The screen display method according to claim 5, wherein the fourth touch operation is a clicking touch operation, and wherein sending the interactive information corresponding to the message prompt control to the third virtual character selected by the fourth touch operation further comprises:
in response to a clicking touch operation for the message prompt control, determining the virtual characters in a same team as the first virtual character, as the third virtual character; and
sending the interactive information corresponding to the message prompt control to the third virtual character.

8. The screen display method according to claim 1, wherein a function control is displayed in the graphical user interface; and wherein the screen display method further comprises:
when the first virtual character is in the following movement state, in response to a fifth touch operation for the function control, entering a voice input state; and
sending voice information received in the voice input state, as interactive information, to a fourth virtual character selected by the fifth touch operation.

9. The screen display method according to claim 1, wherein a function control is displayed in the graphical user interface; and wherein the screen display method further comprises:
when the first virtual character is in the following movement state, in response to a sixth touch operation for the function control, controlling the first virtual character to exit the following movement state.

10. The screen display method according to claim 1, wherein a following cancellation control is displayed in the graphical user interface; and
wherein the screen display method further comprises:
when the first virtual character is in the following movement state, in response to a seventh touch operation for the following cancellation control, controlling the first virtual character to exit the following movement state.

11. The screen display method according to claim 1, wherein the following instruction is generated by:
generating the following instruction, in response to that a following condition meets a preset following requirement, wherein that the following condition meets the preset following requirement comprises at least one of:
receiving a following movement instruction for controlling the first virtual character to move in a game scene; or
the first virtual character entering an area associated with the target virtual character.

12. The screen display method according to claim 5, wherein the message prompt control is determined by:
determining the message prompt control according to one or more of first reference parameters; a character attribute of the first virtual character; a team attribute of a team to which the first virtual character belongs; and a game task currently executed by the first virtual character,
wherein the character attribute comprises one or more of character health point, character defense power, character attack power, character damage power, and a position where the character is located, and
wherein the team attribute comprises one or more of team game progress, a quantity of surviving teammates in the team, and positions where the teammates in the team are located.

13. The screen display method according to claim 1, wherein a function control is displayed in the graphical user interface; and wherein the screen display method further comprises:
when the first virtual character is in the following movement state, in response to an eighth touch operation for the function control, controlling the first virtual character to attack an adversarial virtual character.

14. The screen display method according to claim 1, wherein character identifiers of followable virtual characters are displayed in the graphical user interface; and wherein the screen display method further comprises:
when the first virtual character is in the following movement state, in response to a ninth touch operation for the character identifiers of the followable virtual characters, selecting a followed virtual character other than the target virtual character from the followable virtual characters; and
controlling the first virtual character to follow the followed virtual character to move in the virtual space.

15. (canceled)

16. An electronic device, comprising a processor, a memory, and a bus, wherein the memory stores machine-readable instructions executable by the processor, wherein when the electronic device is running, the processor communicates with the memory through the bus, and the machine-readable instructions, when executed by the processor, perform steps of a screen display method, with the screen display method comprising:
when a first virtual character corresponding to the electronic device is in a non-following movement state, controlling the first virtual character to move in a virtual space in response to a movement instruction, and displaying a first game screen of the virtual space where the first virtual character is located, in a graphical user interface, wherein a graphical user interface is provided by the electronic device, and a part of a game scene is displayed in the graphical user interface; and
in response to a following instruction, controlling the first virtual character to enter a following movement state, and in a first preset area of the graphical user interface, displaying a second game screen of virtual spaces where other virtual characters are located, wherein the first preset area does not completely block the first game screen, and the following movement state of the first virtual character is a state in which the first virtual character moves automatically according to a movement of a target virtual character in the virtual space.

17. A non-transitory computer-readable storage medium, with a computer program stored thereon, wherein the computer program, when executed by a processor, performs steps of a screen display method, with the screen display method comprising:
when a first virtual character corresponding to a terminal is in a non-following movement state, controlling the first virtual character to move in a virtual space in response to a movement instruction, and displaying a first game screen of the virtual space where the first virtual character is located, in a graphical user interface, wherein a graphical user interface is provided by the terminal, and a part of a game scene is displayed in the graphical user interface; and
in response to a following instruction, controlling the first virtual character to enter a following movement state, and in a first preset area of the graphical user interface, displaying a second game screen of virtual spaces where other virtual characters are located, wherein the first preset area does not completely block the first game screen, and the following movement state of the first virtual character is a state in which the first virtual character moves automatically according to a movement of a target virtual character in the virtual space.

18. The screen display method according to claim 1, wherein controlling the first virtual character to move in the virtual space in response to the movement instruction comprises:
in response to determining that a first player presses an operation key corresponding to a movement control, delivering the movement instruction for controlling the first virtual character to move in the virtual space, and controlling the first virtual character to move in the virtual space, wherein the first player is capable of delivering a movement instruction by clicking and dragging or a preset combination keys.

19. The screen display method according to claim 1, wherein the movement instruction comprises a moving speed, a moving direction, and a moving mode.

20. The screen display method according to claim 11, wherein the first virtual character is triggered to enter the following movement state by accepting a following invitation sent by the target virtual character.

21. The screen display method according to claim 8, wherein the fifth touch operation is a sliding touch operation, a clicking touch operation, a double-clicking touch operation, a long-pressing touch operation, or a combined operation of a long-pressing touch operation and a sliding touch operation.
